(19) United States
(12) Patent Application Publication
(10) Pub. No.: US 2005/0117242 A1
(43) Pub. Date: Jun. 2, 2005

(54) Perpendicular magnetic head and perpendicular magnetic disk apparatus

(75) Inventor: Tomoko Taguchi, Kunitachi-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/995,555

(22) Filed: Nov. 24, 2004

(30) Foreign Application Priority Data
Nov. 28, 2003 (JP) 2003-400792

(51) Int. Cl. G11B 5/02; G11B 21/02; G11B 5/127; G11B 5/187

(52) U.S. Cl. 360/59; 360/75; 360/69; 360/110; 360/122

(57) ABSTRACT

A perpendicular magnetic disk apparatus has a perpendicular two-layered film medium including a soft underlayer and a perpendicular magnetic recording layer, a write head including a main pole, a return yoke and an exciting coil, which produces a perpendicular magnetic field, and a heater located near the main pole.

### CROSS-REFERENCE TO RELATED APPLICATIONS

This application is based upon and claims the benefit of priority from prior Japanese Patent Application No. 2003-400792, filed Nov. 28, 2003, the entire contents of which are incorporated herein by reference.

### BACKGROUND OF THE INVENTION

1. Field of the Invention

The present invention relates to a perpendicular magnetic head and a perpendicular magnetic disk apparatus.

2. Description of the Related Art

A perpendicular recording magnetic disk apparatus comprises a magnetic disk (a so-called perpendicular two-layered film medium), and a perpendicular magnetic head. The magnetic disk includes a soft underlayer made of a high-permeability material, and a perpendicular recording layer having perpendicular magnetic anisotropy. The perpendicular magnetic head has a main pole made of a high-permeability material, a return yoke, and an exciting coil, which produces a perpendicular magnetic field.

In a conventional perpendicular magnetic head, however, a perpendicular field component larger than the anisotropy field of the medium easily remains at the distal end portion of the main pole after a write operation, and degrades information already recorded on the medium. This perpendicular field component remaining in the main pole is irregular in both magnitude and frequency of occurrence. Therefore, it is difficult to suppress the residual perpendicular magnetic field in the main pole only by controlling the material or shape of the main pole.

It should be noted that a technique is known which heats a magnetic pole in order to prevent the phenomenon in which stress acts on the magnetic pole due to a temperature change of the magnetic pole before and after writing data, a magnetic domain formed during the writing remains, and the movement of this magnetic domain is detected as noise (Jpn. Pat. Appln. KOKAI Publication No. 4-305809). In this technique, however, the entire surface of the return yoke is heated, so the pole may extend toward the disk because of thermal expansion if excessively heated.

### BRIEF SUMMARY OF THE INVENTION

A perpendicular magnetic head according to an aspect of the present invention comprises: a write head comprising a main pole, a return yoke and an exciting coil, which produces a perpendicular magnetic field; and a heater located near the main pole.

A perpendicular magnetic disk apparatus according to another aspect of the present invention comprises: a perpendicular two-layered film medium comprising a soft underlayer and a perpendicular magnetic recording layer; a write head comprising a main pole, a return yoke and an exciting coil, which produces a perpendicular magnetic field; and a heater located near the main pole.

### BRIEF DESCRIPTION OF THE SEVERAL VIEWS OF THE DRAWING

FIG. 1 is a perspective view showing a magnetic head according to a first embodiment;

FIG. 2 is a sectional view showing a magnetic head and a magnetic disk of a perpendicular magnetic disk apparatus according to the first embodiment;

FIG. 3 is a plan view showing an example of a heater used in the magnetic head according to the first embodiment;

FIG. 4 is a block diagram showing an example of a control circuit for the heater used in the magnetic head according to the first embodiment;

FIGS. 5A and 5B are schematic views each showing energy states of magnetic domains in a main pole;

FIG. 6A is a graph showing the read output waveform of a signal already recorded on the medium;

FIG. 6B is a graph showing the change in write current during overwriting;

FIG. 6C is a graph showing the read output waveform of a signal already recorded on the medium and detected after overwriting is performed using a conventional magnetic head;

FIG. 7A is a graph showing the read output waveform of a signal already recorded on the medium;

FIG. 7B is a graph showing the change in write current during overwriting;

FIG. 7C is a graph showing the read output waveform of a signal already recorded on the medium and detected after overwriting is performed by using the magnetic head according to the first embodiment;

FIG. 8 is a block diagram showing another example of a control circuit for the heater used in the magnetic head according to the first embodiment;

FIG. 9 is a sectional view showing a magnetic head and a magnetic disk of a perpendicular magnetic disk apparatus according to a second embodiment;

FIG. 10 is a sectional view showing a magnetic head and a magnetic disk of a perpendicular magnetic disk apparatus according to a third embodiment;

FIG. 11 is a perspective view showing a magnetic head according to a fourth embodiment;

FIG. 12 is a plan view showing an example of a heater used in the magnetic head according to the fourth embodiment; and

FIG. 13 is a plan view showing another example of a heater used in the magnetic head according to the fourth embodiment.

### DETAILED DESCRIPTION OF THE INVENTION

Embodiments of the present invention will be described below with reference to the accompanying drawings.

### First Embodiment

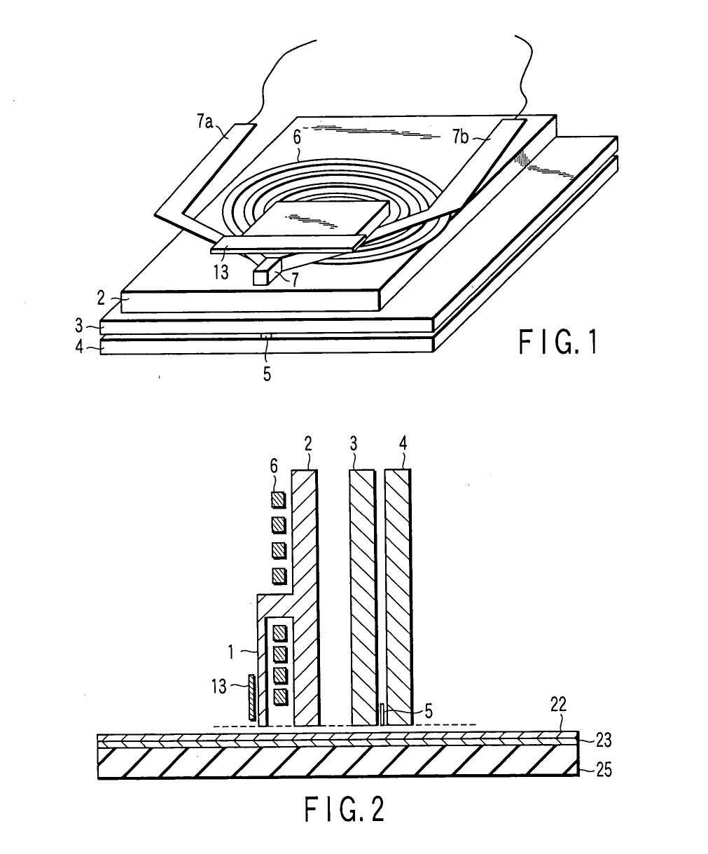

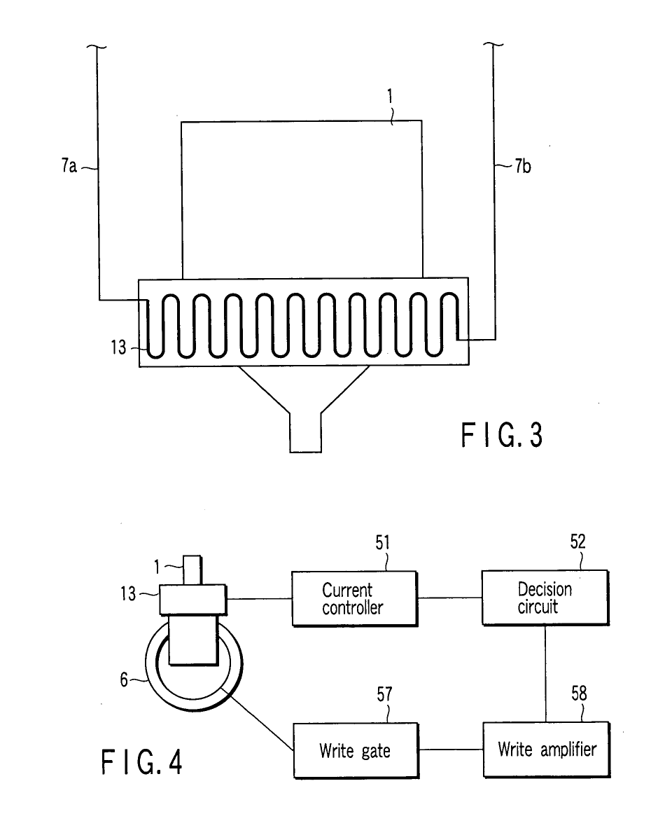

FIG. 1 is perspective view showing a magnetic head according to a first embodiment of the present invention. FIG. 2 is a sectional view showing a magnetic head and a magnetic disk used in a perpendicular magnetic disk apparatus according to the first embodiment. FIG. 3 is a plan view showing an example of a heater used in the magnetic head according to the first embodiment. FIG. 4 is a block diagram showing an example of a control circuit for the heater used in the magnetic head according to the first embodiment.

As shown in FIG. 2, the magnetic disk is a so-called perpendicular two-layered film medium having a soft underlayer 23 and a perpendicular recording layer 22 formed on a substrate 25. The perpendicular recording layer 22 has anisotropy perpendicular to the disk surface.

The magnetic head shown in FIGS. 1 and 2 is a separated magnetic head in which a write head and a read head are separated.

The write head comprises a main pole 1, a return yoke 2 located on the leading side of the main pole 1, and an exciting coil 6. A heater 13 is located, in contact with or not in contact with the main pole 1, on the trailing side of the main pole 1. The heater 13 opposes that a narrowed neck portion (or a tapered portion) of the main pole 1 that changes from a wide portion far from the air-bearing surface (ABS) to a narrow portion close to the air-bearing surface (ABS). The main pole 1 is made of a high-permeability material, and produces a magnetic field perpendicular to the magnetic disk surface. The return yoke 2 forms a magnetic path between the main pole 1 and the soft underlayer 23 of the magnetic disk. The exciting coil 6 is wound around a connecting portion between the main pole 1 and the return yoke 2, and excites the main pole 1 to produce magnetic flux. As shown in FIG. 3, for example, the heater 13 is made of a conductor which is a zigzagged wire. The heater 13 is connected to current electrodes 7a and 7b.

The read head comprises a magnetoresistive film 5, and shield films 3 and 4 arranged on the trailing side and the leading side, respectively, so as to sandwich the magnetoresistive film 5.

As shown in FIG. 4, a control circuit for the heater is constituted by a current controller 51 controlling a current to the heater 13, a decision circuit 52 deciding the operation of the current controller 51, a write gate 57 which supplies a current to the exciting coil 6, and a write amplifier 58. The write amplifier 58 is connected to the decision circuit 52. The decision circuit 52 controls the current to the heater 13 by interlocking it with the current supplied to the exciting coil 6. The operation decision by the decision circuit 52 is so controlled that a current is supplied to the heater 13 during a write operation and for a predetermined time after the write operation. In this control, if I is the current supplied to the heater 13 during the write operation, and R is the resistance of the heater 13, the current is preferably controlled by the current controller 51 so that R×I² is constant. The time at which the supply of a current to the heater 13 is terminated is preferably less than one second after the completion of the write operation. It is also possible to record a control pattern in the end portion of a data sector of the disk at a frequency which is half or more the highest frequency, and supply a current to the heater 13 until this control pattern is completed.

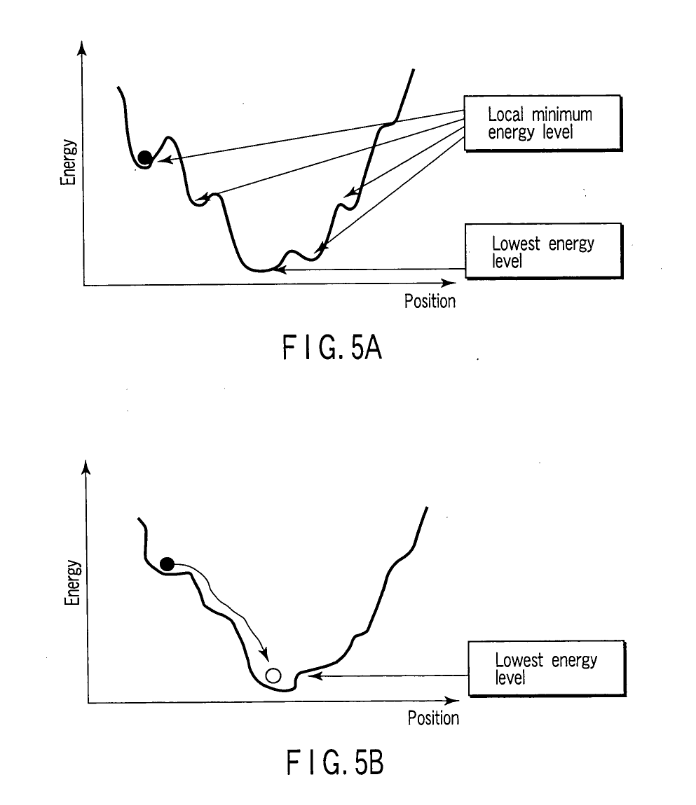

FIG. 5A is a graph showing energy states of magnetic domains in the main pole. The lowest energy level is in a state that all magnetization in the entire magnetic domain is parallel to the easy axis, i.e., parallel to the medium surface. In the main pole 1, however, a plurality of local minimum energy levels exist in addition to the lowest energy level. In a magnetic domain in the state of this local minimum energy level other than the lowest energy level, magnetization is not completely parallel to the medium surface, i.e., magnetization having a perpendicular component remains. If, for example, a write operation is abruptly terminated, the energy state of a magnetic domain in the main pole does not fall to the lowest energy level in some cases, and remains at the local minimum energy level. Referring to FIG. 5A, for example, the energy state of a magnetic domain in the main pole is at the local minimum energy level indicated by a solid circle. In this case, a perpendicular field component remains at the distal end portion of the main pole, and degrades or erases information already recorded on the medium.

The energy state of the magnetic domain in the main pole shown in FIG. 5A can be changed by exposing the main pole to a high temperature. When the main pole is exposed to a high temperature, a state having no local minimum levels can be obtained, as shown in, e.g., FIG. 5B.

In the present invention, the heater 13 is located near the main pole 1 in order to obtain a state having no or few local minimum levels when a write operation is terminated. After the write operation is terminated, a current is supplied to the heater 13 for only a certain time to heat the main pole 1, so that the energy state of a magnetic domain in the main pole falls to the lowest energy level. Consequently, all magnetization in the main pole becomes parallel to the medium surface as the direction of easy axis, so that a perpendicular field component is no longer applied from the main pole to the medium. Accordingly, information already recorded on the medium is not degraded or erased after a write operation is terminated.

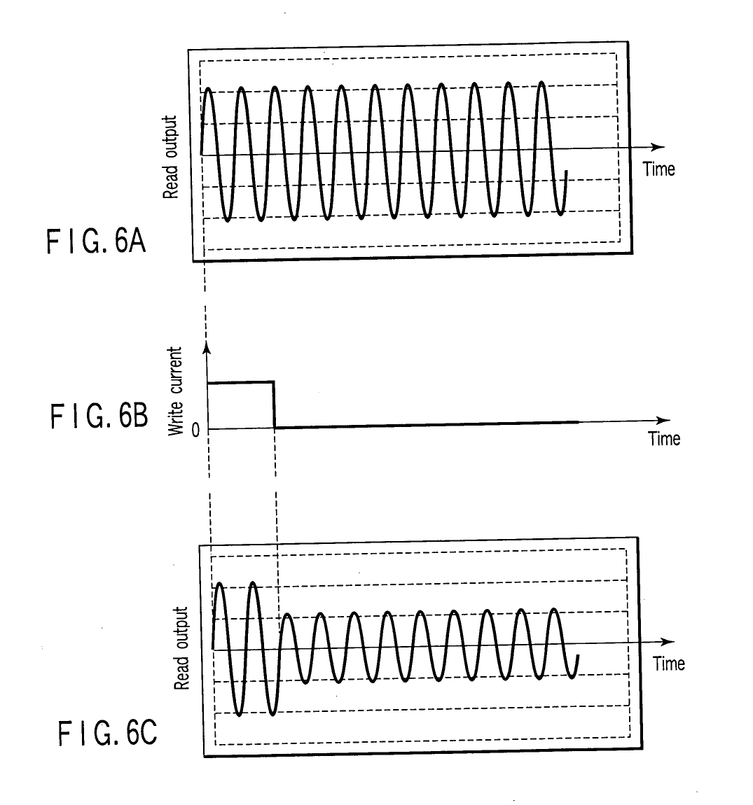

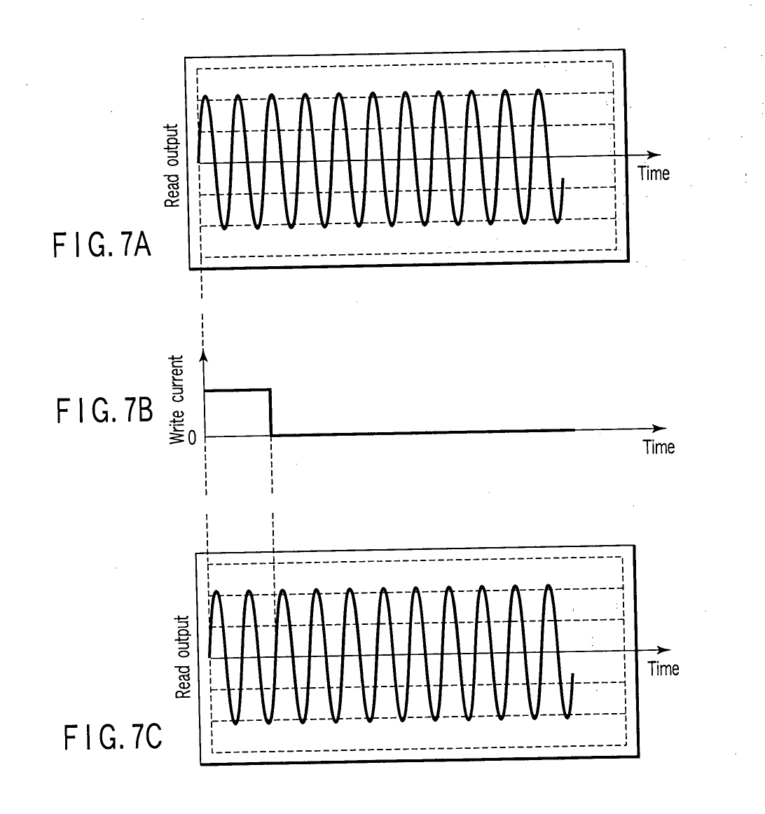

FIGS. 6A to 6C are graphs showing the results when read outputs are checked before and after overwriting using the conventional magnetic head. FIGS. 7A to 7C are graphs showing the results when read outputs are checked before and after overwriting using the magnetic head of this embodiment.

FIGS. 6A and 7A illustrate the read output waveforms of signals already recorded on the medium. FIGS. 6B and 7B are graphs each showing the change in write current during overwriting. FIGS. 6C and 7C illustrate the read output waveforms of signals after overwriting.

When the conventional magnetic head was used, as shown in FIG. 6C, the output of the already recorded signal fell after the write current was terminated. In contrast, when the magnetic head of this embodiment was used, as shown in FIG. 7C, no degradation of the output of the already recorded signal was found after the write current was terminated.

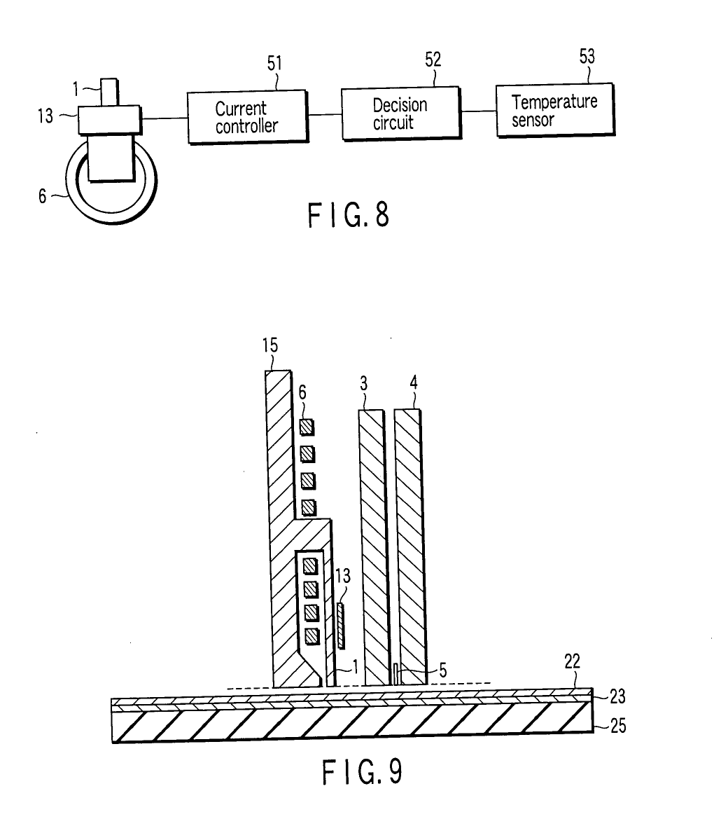

It should noted that the control circuit for the heater is not limited to that shown in FIG. 4, and a control circuit as shown in FIG. 8 may also be used. The control circuit for the heater shown in FIG. 8 comprises a current controller 51 for controlling the current to the heater 13, a decision circuit 52 for deciding the operation of the current controller 51, and a temperature sensor 53 connected to the decision circuit 52 and installed in a hard disk drive (HDD). This control circuit decides the operation in accordance with the internal temperature of the HDD. For example, the current controller 51 controls the current supplied to the heater 13 so that the resistance of the heater 13 is larger than that at room temperature. This is so because magnetic domains in the main pole 1 readily become unstable at low temperatures, and this increases the probability that a perpendicular magnetization component will remain at the distal end portion of the main pole immediately after a write operation, making it necessary to avoid a low-temperature operation of the main pole during HDD operation.

### Second Embodiment

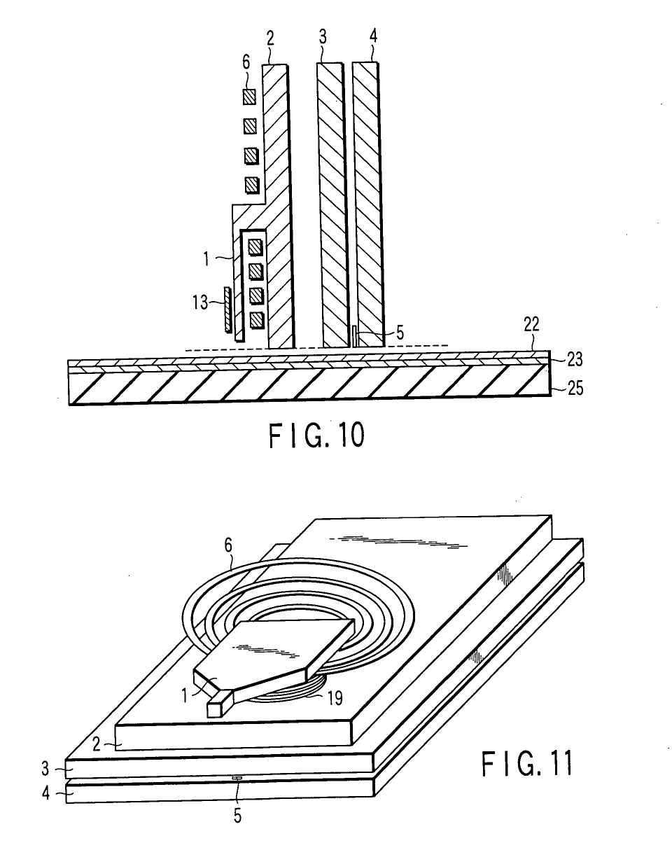

FIG. 9 is a sectional view showing a magnetic head and a magnetic disk of a perpendicular magnetic disk apparatus according to a second embodiment.

The magnetic head shown in FIG. 9 is a separated magnetic head in which a write head and a read head are separated. Referring to FIG. 9, the write head comprises a main pole 1, a return yoke 15 located on the trailing side of the main pole 1, and an exciting coil 6. Also, a heater 13 is located, in contact with or not in contact with the main pole 1, on the leading side of the main pole 1.

The arrangement of the read head and the arrangement of the magnetic disk are the same as in the first embodiment. The shape and position of the heater 13 are also the same as in the first embodiment. As a control circuit for the heater, the circuit shown in FIG. 4 or 8 explained in the first embodiment is used.

Even when the write head shown in FIG. 9 is used, information already recorded on the medium is not degraded or erased after a write operation is terminated.

### Third Embodiment

FIG. 10 is a sectional view showing a magnetic head and a magnetic disk of a perpendicular magnetic disk apparatus according to a third embodiment.

The magnetic head shown in FIG. 10 is a separated magnetic head in which a write head and a read head are separated. The write head comprises a main pole 1, a return yoke 2 located on the leading side of the main pole 1, and an exciting coil 6. The distal end portion of the main pole 1 is recessed relative to the air-bearing surface (ABS) of the magnetic head. The recess amount is desirably 0.1 μm or less. Also, a heater 13 is located, in contact with or not in contact with the main pole 1, on the trailing side of the main pole 1.

The arrangement of the read head and the arrangement of the magnetic disk are the same as in the first embodiment. The shape and position of the heater 13 are also the same as in the first embodiment. As a control circuit for the heater, the circuit shown in FIG. 4 or 8 explained in the first embodiment is used.

In the magnetic head shown in FIG. 10, the main pole 1 expands as a result of thermal conduction from the heater 13 and comes close to the ABS, thereby performing a write operation.

Even when the write head shown in FIG. 10 is used, information already recorded on the medium is not degraded or erased after a write operation is terminated.

### Fourth Embodiment

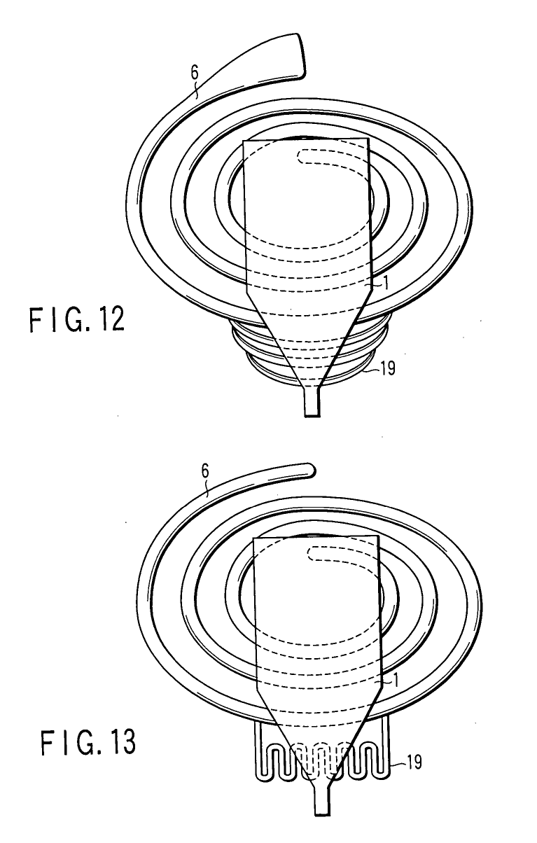

FIG. 11 is a perspective view showing a magnetic head according to a fourth embodiment. FIG. 12 is a plan view showing an example of a heater used in the magnetic head according to the fourth embodiment. FIG. 13 is a plan view showing another example of a heater used in the magnetic head according to the fourth embodiment.

The magnetic head shown in FIG. 11 is a separated magnetic head in which a write head and a read head are separated. The write head comprised a main pole 1, a return yoke 2 located on the leading side of the main pole 1, and an exciting coil 6. As shown in FIG. 12, a heater 19 made of a plurality of wires branched from the exciting coil 6 is located on the leading side of a tapered portion of the main pole 1.

As shown in FIG. 13, a heater 19 made of a zigzagged wire branched from the exciting coil 6 may also be located on the leading side of the tapered portion of the main pole 1.

The arrangement of the read head and the arrangement of the magnetic disk are the same as in the first embodiment. As a control circuit for the heater, the circuit shown in FIG. 4 or 8 explained in the first embodiment is used.

In the fourth embodiment, a current is also supplied to the heater 19 branched from the exciting coil 6 during a write operation, so the main pole 1 is constantly heated during the write operation and is not abruptly cooled even immediately after the write operation. Therefore, no local minimum levels exist in the main pole, the states of magnetic domains fall to the lowest energy level, and all magnetization is parallel to the easy-axis and so is stable. This prevents a perpendicular field component from remaining at the distal end portion of the main pole after a write operation is terminated, and prevents degradation or erasure of information already recorded on the medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A perpendicular magnetic head comprising:
a write head comprising a main pole, a return yoke and an exciting coil, which produces a perpendicular magnetic field; and
a heater located near the main pole.

2. The head according to claim 1, wherein the heater opposes a tapered portion of the main pole that changes from a wide portion far from an air-bearing surface to a narrow portion close to the air-bearing surface.

3. The head according to claim 1, wherein the heater is made of a wire branched from the exciting coil.

4. A perpendicular magnetic disk apparatus comprising:
a perpendicular two-layered film medium comprising a soft underlayer and a perpendicular magnetic recording layer;
a write head comprising a main pole, a return yoke and an exciting coil, which produces a perpendicular magnetic field; and
a heater located near the main pole.

5. The apparatus according to claim 4, wherein the heater opposes a tapered portion of the main pole that changes from a wide portion far from an air-bearing surface to a narrow portion close to the air-bearing surface.

6. The apparatus according to claim 4, wherein the heater is made of a wire branched from the exciting coil.

7. The apparatus according to claim 4, further comprising a current controller connected to the heater, and a decision circuit.

8. The apparatus according to claim 7, further comprising a temperature sensor sensing an internal temperature of the apparatus.
